(19) United States
(12) Patent Application Publication
(10) Pub. No.: US 2014/0089287 A1
(43) Pub. Date: Mar. 27, 2014

(54) INFORMATION SPACE EXPLORATION TOOL SYSTEM AND METHOD

(71) Applicant: Information Exploration, LLC, Bloomington, IN (US)

(72) Inventors: Sean Ryan Connolly, Bloomington, IN (US); Brent Kievit-Kylar, Bloomington, IN (US)

(73) Assignee: Information Exploration, LLC, Bloomington, IN (US)

(21) Appl. No.: 14/036,826

(22) Filed: Sep. 25, 2013

Related U.S. Application Data
(60) Provisional application No. 61/871,648, filed on Aug. 29, 2013.
(60) Provisional application No. 61/705,531, filed on Sep. 25, 2012.

(51) Int. Cl. G06F 17/30

(52) U.S. Cl. CPC G06F 17/30873
USPC 707/707; 707/722

(57) ABSTRACT

The present invention involves a computer implemented system and method which assists querying against a data space using visualization. The method uses a computer to visualize a query of the data space by an initial search parameter. A first set of objects resulting from the initial search parameter is displayed, and the first set of objects on the display is graphically manipulated. A second set of objects is then created from a new query based on the initial search parameter and the graphic manipulation of the first set of objects. The user may link various objects, and assign a quantitative or qualitative value with each link. Information spaces may be created based on such manipulations and/or links, and portions of the information spaces may be extracted and/or inserted into or out of external information spaces.

### CROSS-REFERENCE TO RELATED APPLICATIONS

The present application claims priority under 35 U.S.C. §119(e) of U.S. Patent Provisional Application Ser. Nos. 61/705,531 and 61/871,648, filed Sep. 25, 2012, and Aug. 29, 2013, respectively, the disclosures of which are incorporated by reference herein.

### SOURCE CODE APPENDIX

This application includes a computer software pseudo-code listing appendix submitted at the end of this patent specification document. A portion of the disclosure of this patent document may contain material which is the subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The invention relates to data visualization software. More specifically, the field of the invention is that of visualization software for large amounts of data.

2. Description of the Related Art

Searching data bases has existed since the beginning of data storage. Initially, searching was a crude process of matching desired strings of information in a particular data file. Search techniques have evolved and have become more user friendly. For example, data is now stored in relational databases with predetermined data fields. Also, textual information can also be searched by free text searches, either in a library of text documents. Organizing and presenting the data and the search results continues to be an area of great interest in computing.

Browsers are computer programs that provide user access to displays of web pages. Often, users navigate the world-wide web of the internet by the use of search engines accessed through the browsers. User information stored by the browser (typically in files called “cookies”) is often used by the search engines to inform the search results. However, the user has only a limited ability to guide the search by allowing access to the stored browser information.

When a user queries a largely unstructured database, the search algorithm essentially makes predictions about ‘what it thinks the user is thinking.’ In the context of web pages, the first step is usually to turn each searched page into a ‘bag of words’ that contain no semantic or grammatical meaning. The ‘bag’ is just a ‘bag’ of word-symbols which the algorithm matches up against the word-symbols used by the user to query. Systems like Google add additional layers like their Page-Rank algorithm. PageRank considers the other webpages that link to the original page, and consider that linkage a ‘vote’ in favor of the original page. By tallying a complex assortment of votes, PageRank can give a better than just ‘bag of words’-level prediction about ‘what it thinks the user is thinking.’ It then ranks those predictions, in order, in the form of a list.

### SUMMARY OF THE INVENTION

The present invention is a data visualization system and method which allows users to explore information spaces in a semantic manner. In various embodiments, techniques are provided for performing operations on information spaces, with special emphasis on interactive visualization and manipulation of properties of the information space and objects therein. Information spaces may be structured, such as relational databases, or unstructured, such as transaction data sets, or a hybrid, such as a collection of web pages.

In one embodiment, a user may dynamically modify relationships between search items as a means of focusing search results. Embodiments of the invention provide mechanisms for information interactions that allow common users to interact more directly with information retrieval and search algorithms and data. The complicated mathematical relationships of computation are transformed into graphic and textual relationships that more closely approximate ‘the way brains think’ then ‘the way computers think.’

This information technique works primarily on information than may be arranged as meta-objects that may be broken down into domains within which are feature sets. The meta-objects and each of the domains specify the search areas and may be visualized separately or as a single integrated visual element. Each feature in each domain and each meta-object has a location defined in n-dimensional space. This location is indicative of its relevance and relation to the information search. Elements in this space may be directly user generated or computer generated in response to the shape of the information space. When users modify the location of elements in the space, the algorithm generates and moves other objects in the space to refine the search space, effectively guessing what elements the user might want in the search space and at what location they might be wanted. The user may then select elements generated by the computer to confirm or deny the computers prediction. This technique creates a visual search and exploration tool which may interface with and augment existing search algorithms, although it may implement its own search algorithm if required. A focus of this algorithm is consistence in the search space. The space is designed to change slowly in response to modifications such that the user develops an intuition about the space and does not have to rebuild such an intuition with every slight modification that is made to the space.

Embodiments of the present invention address the situation where an initial search query does not produce a sufficiently relevant result. Conventional search technology does not allow a user to refine that query to achieve a more nuanced search. While current search algorithms are excellent in some aspects, the user's ability to interact with the search algorithm is presently limited. The present disclosure presents several ways to extend the ways in which users can interact with information, allowing for greater exploration of information space.

In embodiments of the present invention, the user takes power over the search algorithm. For example, a normal search algorithm only allows one to use the keyword to interact with the program. Embodiments of the invention allow the user to take over the algorithm, by letting the user to assign 200% of value to the keyword (or 500% value, 50% value, or 10%). By letting the user reweight the value of the query words, the user may extend the parameters (and thus prediction ability) of the underlying search algorithm. This reweighting—its interface, interactions, and algorithms—process is described in detail below.

An additional problem that conventional search algorithmic approaches do not easily solve, involve problems that arise from the homonymic, polysemous, and un-standardized nature of language-in-use.

Homonymic refers to words that are spelled the same, but, have different meanings. For example, the word “dog” may refer to a canine, or, it may refer to a sausage/hot dog. Algorithmic approaches to search may navigate this problem somewhat well if other contextual clues are around the words being searched. Polysemous words are different, but similar. These are words or phrases that share the same form, and root, and yet, refer to different meanings. For example, the word “literally” means something is actually true, but also, in use, means that something feels a lot like it is true. The two definitions, oppose each other in meaning. This is more difficult for an algorithm to solve.

A further challenge is that language usage is not standardized, in particular descriptive language. In 1985, Fidel found that when multiple test subjects are asked to describe a simple object like “dog,” only about 20% of the words used in the descriptions are the same. Thus mapping descriptive words to described objects in a generalized way is difficult. As more and more of the web is composed of unstandardized, user-generated content, this ‘not using the same words to describe things’ is becoming a greater and greater problem.

Humans are very good at solving these problems, but they are difficult problems for computer algorithms to solve without assistance. Embodiments of the present invention allow a human user to interact with a computer algorithm to take over the search algorithm and directly tell the tool what specific words mean. This is a step towards taking search science from matching keywords to matching meaning.

The present invention, in one form, relates to a method of using a computer to visualize a query of a data space. First, a first set of objects resulting from an initial search parameter is displayed. The user may graphically manipulate the first set of objects on the display. Then, a second set of objects created from a new query based on the initial search parameter and the graphic manipulation of the first set of objects is displayed.

The present invention, in another form, is a computer system to implement the foregoing method.

Another aspect of the invention relates to a machine-readable program storage device for storing encoded instructions for a method of visualizing a query of a data space according to the foregoing method.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3A is a schematic depiction of an information space according to an embodiment of the present invention. FIGS. 3B and 3C are more detailed depictions of how properties apply to the information space and objects and meta-objects in various embodiments.

FIG. 4A illustrates operations that may, in various embodiments, be performed with and on the information space and its objects. FIG. 4B illustrates a merging operation according to one embodiment. FIG. 4C illustrates a splitting operation according to one embodiment.

FIG. 5 depicts two further operations on an information space according to embodiments of the present invention.

FIG. 6A illustrates a query operation according to one embodiment of the invention. FIG. 6B is a flow chart diagram of the operation of the present invention relating to human machine interaction in a query. FIGS. 6C and 6D illustrate how embodiments of the invention provide users immediate feedback for reflection about a query.

FIG. 7 illustrates creation of a query according to an embodiment of the invention.

FIGS. 8A and 8B are schematic diagrams of the operation of an example of linking words in an embodiment of the present invention.

FIG. 9 shows a screen shot of the Daedelus data visualization tool in use.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

The present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The term “search” in the context of navigating the internet, means matching a query against a set of web content and returning an ordered list of matching items—usually web pages or images. The term “big data” means a collection of data and/or information which is of a sufficiently large amount, in terms of amount of storage required and information contained, and sufficiently complex data relations, in terms of the relationship between the various instances and attributes of the data, which make conventional data manipulation techniques difficult to accomplish. The type of conventional data manipulation includes processes such as insertion, modification, and search, and big data manipulation is difficult to accomplish within reasonable amounts of time. Thus, classification of “big data” is dependent both on size and complexity, and changes as computation hardware becomes quicker and more adept.

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

In wireless wide area networks, communication primarily occurs through the transmission of radio signals over analog, digital cellular or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, Calif.), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

In the following specification, the term “social network” may be used to refer to a multiple user computer software system that allows for relationships among and between users (individuals or members) and content assessable by the system. Generally, a social network is defined by the relationships among groups of individuals, and may include relationships ranging from casual acquaintances to close familial bonds. In addition, members may be other entities that may be linked with individuals. The logical structure of a social network may be represented using a graph structure. Each node of the graph may correspond to a member of the social network, or content assessable by the social network. Edges connecting two nodes represent a relationship between two individuals. In addition, the degree of separation between any two nodes is defined as the minimum number of hops required to traverse the graph from one node to the other. A degree of separation between two members is a measure of relatedness between the two members.

Social networks may comprise any of a variety of suitable arrangements. An entity or member of a social network may have a profile and that profile may represent the member in the social network. The social network may facilitate interaction between member profiles and allow associations or relationships between member profiles. Associations between member profiles may be one or more of a variety of types, such as friend, co-worker, family member, business associate, common-interest association, and common-geography association. Associations may also include intermediary relationships, such as friend of a friend, and degree of separation relationships, such as three degrees away. Associations between member profiles may be reciprocal associations. For example, a first member may invite another member to become associated with the first member and the other member may accept or reject the invitation. A member may also categorize or weigh the association with other member profiles, such as, for example, by assigning a level to the association. For example, for a friendship-type association, the member may assign a level, such as acquaintance, friend, good friend, and best friend, to the associations between the member's profile and other member profiles.

Each profile within a social network may contain entries, and each entry may comprise information associated with a profile. Examples of entries for a person profile may comprise contact information such as an email addresses, mailing address, instant messaging (or IM) name, or phone number; personal information such as relationship status, birth date, age, children, ethnicity, religion, political view, sense of humor, sexual orientation, fashion preferences, smoking habits, drinking habits, pets, hometown location, passions, sports, activities, favorite books, music, TV, or movie preferences, favorite cuisines; professional information such as skills, career, or job description; photographs of a person or other graphics associated with an entity; or any other information or documents describing, identifying, or otherwise associated with a profile. Entries for a business profile may comprise industry information such as market sector, customer base, location, or supplier information; financial information such as net profits, net worth, number of employees, stock performance; or other types of information and documents associated with the business profile.

A member profile may also contain rating information associated with the member. For example, the member may be rated or scored by other members of the social network in specific categories, such as humor, intelligence, fashion, trustworthiness, sexiness, and coolness. A member's category ratings may be contained in the member's profile. In one embodiment of the social network, a member may have fans. Fans may be other members who have indicated that they are “fans” of the member. Rating information may also include the number of fans of a member and identifiers of the fans. Rating information may also include the rate at which a member accumulated ratings or fans and how recently the member has been rated or acquired fans.

A member profile may also contain social network activity data associated with the member. Membership information may include information about a member's login patterns to the social network, such as the frequency that the member logs in to the social network and the member's most recent login to the social network. Membership information may also include information about the rate and frequency that a member profile gains associations to other member profiles. In a social network that comprises advertising or sponsorship, a member profile may contain consumer information. Consumer information may include the frequency, patterns, types, or number of purchases the member makes, or information about which advertisers or sponsors the member has accessed, patronized, or used.

A member profile may comprise data stored in memory. The profile, in addition to comprising data about the member, may also comprise data relating to others. For example, a member profile may contain an identification of associations or virtual links with other member profiles. In one embodiment, a member's social network profile may comprise a hyperlink associated with another member's profile. In one such association, the other member's profile may contain a reciprocal hyperlink associated with the first member's profile. A member's profile may also contain information excerpted from another associated member's profile, such as a thumbnail image of the associated member, his or her age, marital status, and location, as well as an indication of the number of members with which the associated member is associated. In one embodiment, a member's profile may comprise a list of other social network members' profiles with which the member wishes to be associated.

An association may be designated manually or automatically. For example, a member may designate associated members manually by selecting other profiles and indicating an association that may be recorded in the member's profile. According to one embodiment, associations may be established by an invitation and an acceptance of the invitation. For example, a first user may send an invitation to a second user inviting the second user to form an association with the first user. The second user may accept or reject the invitation. According to one embodiment, if the second user rejects the invitation, a one-way association may be formed between the first user and the second user. According to another embodiment, if the second user rejects the association, no association may be formed between the two users. Also, an association between two profiles may comprise an association automatically generated in response to a predetermined number of common entries, aspects, or elements in the two members' profiles. In one embodiment, a member profile may be associated with all of the other member profiles comprising a predetermined number or percentage of common entries, such as interests, hobbies, likes, dislikes, employers and/or habits. Associations designated manually by members of the social network, or associations designated automatically based on data input by one or more members of the social network, may be referred to as user established associations.

Examples of social networks include, but are not limited to, facebook, twitter, myspace, linkedin, pinterest, instagram, and other systems. The exact terminology of certain features, such as associations, fans, profiles, etc. may vary from social network to social network, although there are several functional features that are common to the various terms. Thus, a particular social network may have more of less of the common features described above. In terms of the following disclosure, generally the use of the term “social network” encompasses a system that includes one or more of the foregoing features or their equivalents.

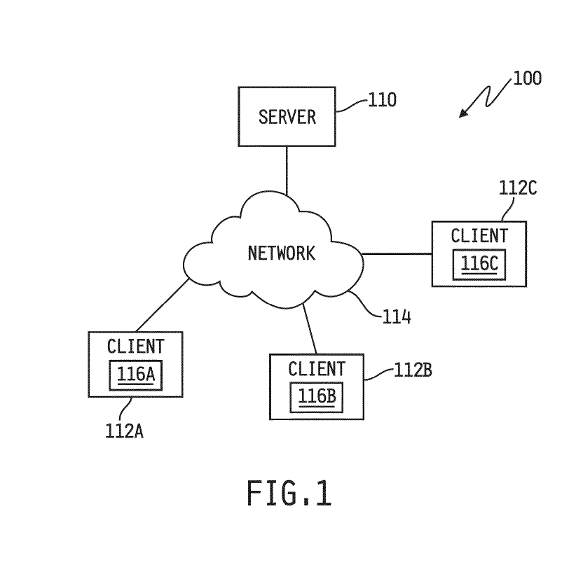

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

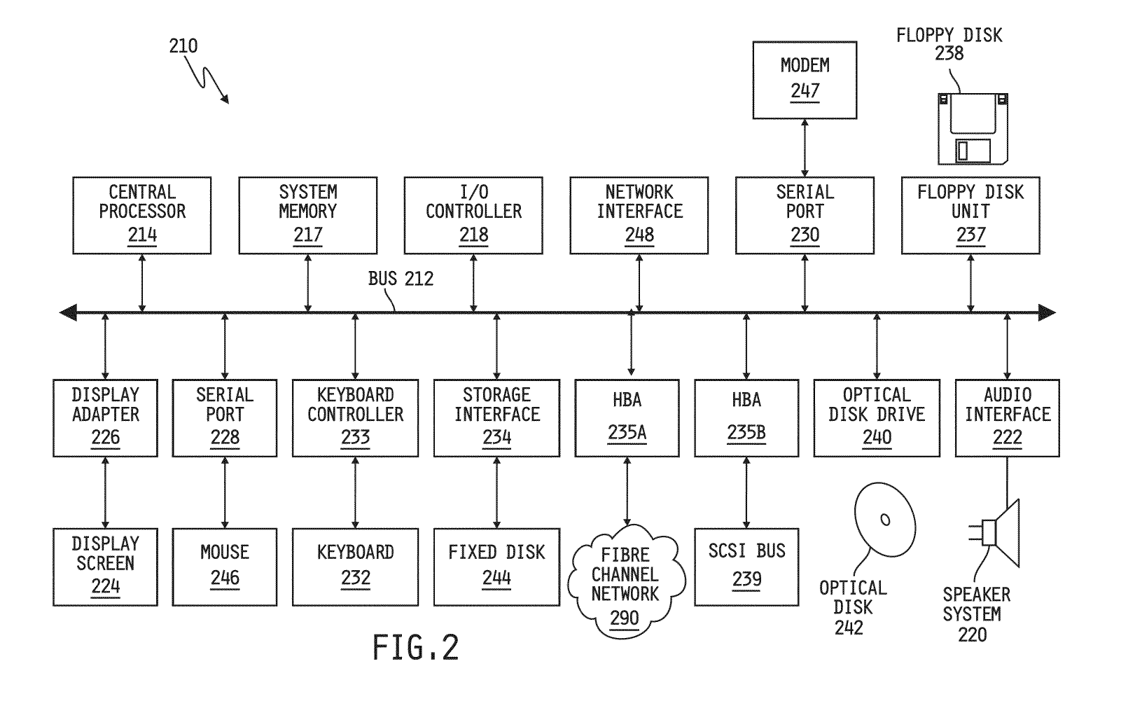

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

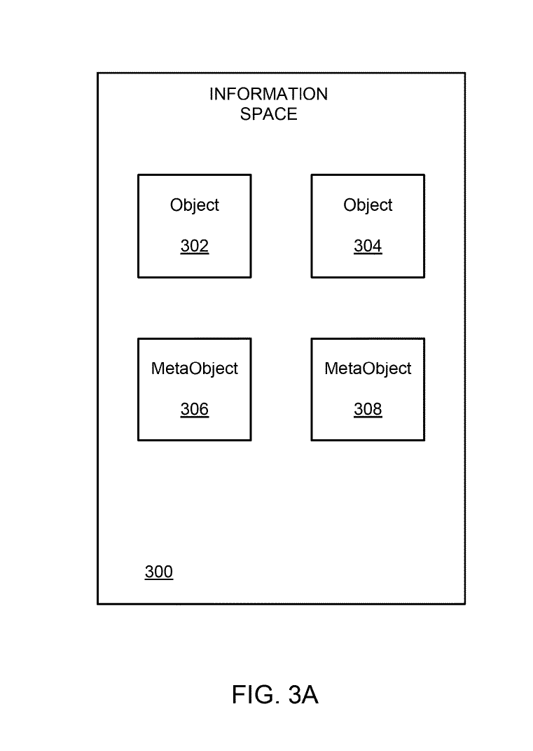

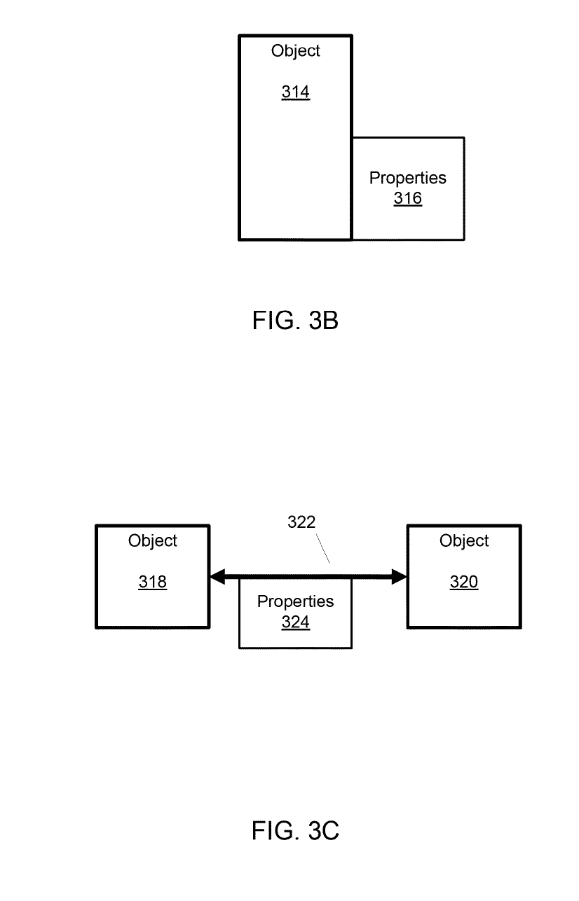

FIG. 3A is a schematic depiction of an information space according to an embodiment of the present invention. The information space can be modeled as an n-dimensional composite of objects and meta-objects. Note that the information space may be referred to by a number of terms, for example data space, abstraction, mapping, representation, or model can be used.

For illustration, in FIG. 3A information space 300 contains data object 302, data object 304, and meta-objects 306 and 308. Objects 302 and 304 and meta-objects 306 and 308 represent abstractions and mappings into the information space 300 or an associated data set. Although a small number of objects and meta-objects is shown for illustration, no limit to the number of objects or meta-object is inferred and in fact the data set may be very large and contain many objects. In fact, embodiments of the present invention are intended to help a user understand and search very large sets of data.

FIG. 3B is a more detailed depiction of how properties apply to the information space and objects and meta-objects in various embodiments. Properties may be associated with an object, a meta-object, a group of objects, or with the entire information space. Object 314 is associated with property collection 316. Property list 312 applies to an entire information space 310, thus these are global properties. Properties may, in some embodiments, be defined that relate to how objects and data are presented to a user in a visual environment.

Properties may also describe relations between or among objects or meta-objects. Object 318 and object 320 have relationship 322 described by property list 324 (see FIG. 3C). Relation properties between objects may include similarity, difference, affinity, attraction, repulsion, order in space or time. Semantically a relation or relation property may include concepts such as synonym, antonym, homonym, or polysemy. Although the relation shown is pairwise, i.e. between two objects, relations can be defined between three or more objects. In some embodiments, a relation indicates a position along one or more dimensions in a multi-dimensional space, where the position of objects may be absolute or relative to other objects.

In embodiments of the present invention multiple operations are defined that manipulate and alter the information space and its visualization, as well as properties of various objects in the information space. The list of operations discussed below is not exhaustive, but exemplary.

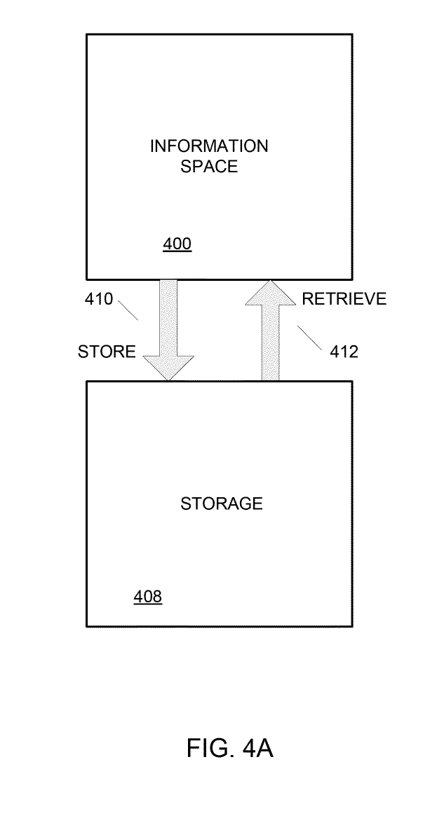

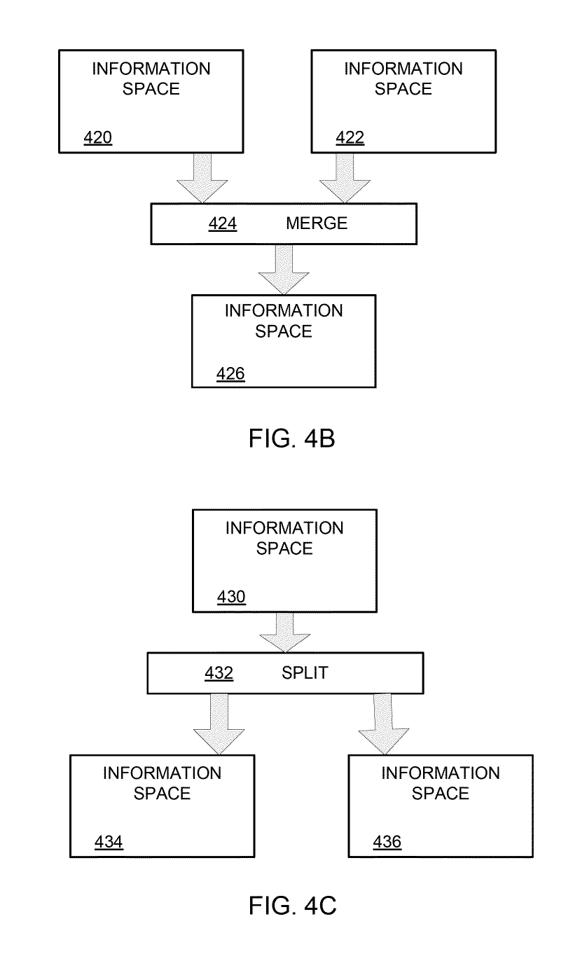

FIG. 4A illustrates operations that may, in various embodiments, be performed with and on the information space and its objects and properties. Information space 400 and data storage 408 can interact in several ways. Storage operation 410 stores a representation of information space 400 in data storage 408. Conversely retrieval operation 412 creates information space 400 from a representation saved in data storage 408. Thus information space 400 can be saved, recalled, moved across a network, or copied. As the information space changes or evolves over time, versions can be saved that represent a snapshot of the state or a checkpoint for reverting to a previous state.

FIG. 4B illustrates a merging operation according to one embodiment. Information space 420 and information space 422 are merged by process 424 to form a new information space 426. Although a binary merge operation is shown, merge operations can, in various embodiments, operate on three or more information spaces.

FIG. 4C illustrates a splitting operation according to one embodiment. Information space 430 is acted upon by splitting operation 432 to form two new information spaces 434 and 436.

In addition to the organization/reorganization of various information spaces, depicted in FIGS. 4A-4C, particular associations and weightings from particular environments may be shared between information spaces. For example, the acronym XYZ may have one meaning in the state of New York, but have a second different meaning in the state of California. The association of XYZ with meaning one may have a property of being very strong in New York, somewhat strong in the states of New Jersey, Pennsylvania, and Connecticut, while the association of XYZ with meaning two may have a property of being strong in California, somewhat strong in Arizona, Oregon, and Nevada, but only weakly associated with either meaning in other states. As another example, the acronym QRST may have one meaning when used by research biochemists, and have a second different meaning when used by industrial roof manufacturers. In this example, the association of QRST with meaning one may have a property of being very strong with research biochemists, somewhat strong with research chemists in general, but only weakly associated with the general population, while the association of QRST with meaning two may have a property of being very strong with industrial roof manufacturers, somewhat strong with other industrial engineers, and only weakly associated with the general population.

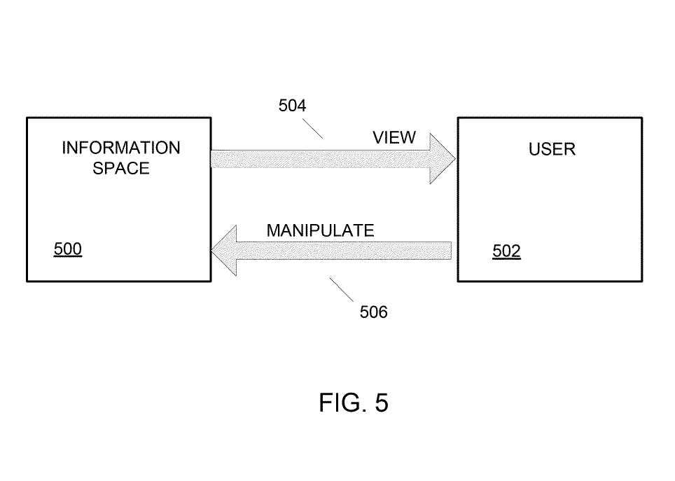

FIG. 5 depicts two further operations on an information space according to embodiments of the present invention. User 502 interacts with information space 500. View operation 504 allows user 502 to inspect or visualize information space 500 and its contents. It can be appreciated that this visualization can be accomplished in many ways, and these are described further in the sections to follow. Control operation 506 provides means for the user to manipulate information space 500 and viewer 504. The combination of information space 500 with viewer 504 and controller 506 provides a powerful framework upon which a number of sophisticated tools and techniques are built. In particular, if the operations 504 and 506 proceed in near-real time such that they appear nearly instantaneous to user 502, the user becomes part of a feedback loop and information space 500 is a dynamic entity.

A variety of visualization techniques and tools are enabled by the framework provided in embodiments of the present invention. Those presented herein are exemplary only. Visualization in various embodiments includes static aspects of a displayed object, such as the color, shape, position, relative position, size, shape or brightness. In other embodiments, dynamic aspects such as attraction, velocity, vibration, rotation and the rates of the dynamic aspects are altered to indicate properties of underlying data for purposes of visualization.

In some embodiments, the data objects are visualized by attaching properties and executing algorithms that make them behave as physical objects. This behavior may include for example, interactions among objects or with a surface on which the objects appear in a visual environment. For example, each object can be associated with a parameter corresponding to a physical mass and then the resulting gravitational attraction used to position the objects in a visual frame. Or each object is assigned a property such as a positive or negative electric charge and the resulting repulsions and attractions modeled to position the objects visually. Or the center of the visual field may be designated as an attractor with different affinity for objects. The properties assigned to objects often reflect aspects of the underlying data or relationships between and among items in the data set so the resulting pattern of static and dynamic behavior offers insight into a data set.

Further embodiments of the invention provide a visualization of time-changing aspects of items in a data set. For example, persistence of data in a data space may be indicated by color, intensity, and/or motion so that elements of the data space that have a greater persistence may be represented by one particular configuration of display, while less persistent data may be represented by another configuration. Thus, a user may shape an investigation based on the ‘scoping’ of the persistent space, providing additional opportunities for feedback and reflection. Such visual display of persistence may provide the user another mechanism for identifying emerging concepts in a data space that may be more apparent in the context of the persistence of data.

In these embodiments, the techniques provide a human user with improved understanding of the data and relationships through the visualization tool, because humans are familiar with interactions of physical objects. The user may manipulate these properties or select an entirely different set of physical attributes to use in visualization the data, as suited for the data set and analysis and the preferences of the user.

The grouping and spacing of actual objects in the information space may occur in n-dimensional space while the visualization only projects two or three dimensions into a visual environment. Thus, the visualization tool provides a window into the n-dimensional relations of the items being displayed. The mapping of the higher-dimensional space into a number of dimensions amenable to human visual comprehension is, in various embodiments, under control of the user interacting with the data.

In addition, in embodiments of the invention relationships between data elements are included in the visualization and visual display. For example, two elements that represent related words are shown as connected by a line, and the color and style of the line indicates the nature of the relationship between the elements.

Any of the techniques described herein for display or data visualization are, in various embodiments, also available to allow a user to manipulate and interact with the objects and elements. For example, if a yellow dashed line indicates a synonym relationship between two word-objects in the visual environment, then the user interface can provide means for creating a yellow dashed line so the user can add that relationship.

Embodiments of the present invention are generally adapted to enhance investigation of a data space. Such an investigation may include a search of the data space for relevant pieces of information. Other investigations may be more properly considered data mining, where the user attempts to discover previously unknown patterns in the data space, to obtain new data clusters, identify anomalies, and reveal dependencies or correlations. Other investigations may relate to data modeling, where hypothetical relationships may be created and tested against a data space or subsections of the data space.

In one embodiment, the user may produce multiple views of a single data set. These multiple views may correspond to different points in time, different mappings of higher dimensions into visual space, to application of different visualization techniques, or to modification of object properties. As described above, views may be saved and later viewed, such that a user can compare multiple views of a data space. For example, multiple windows can be simultaneously displayed in various manners, such as side-by-side or overlayed, where each window offers a different view.

Various embodiments of the invention utilize visualizations of individual query parameters, data instances, and data instance groups so that users may manipulate graphic representations of such objects. Users thus may interact with graphic symbols in a particular data space, where the movement of such objects in the data space relates to a property or evaluation of the manipulated object. In addition, objects may be grouped or related by the user to create meta-objects which may be manipulated in much the same way as other objects. Further graphic symbols may be used to represent computational elements with which the user may interact.

Using the visualization tool of embodiments of the present invention, a user may create a particularly refined data space for finding and/or analyzing data. In such cases, once the user specifies a data set, for example a series of laboratory readings, a database of financial transactions, or web pages from the Internet, the user may create an initial set of parameters for defining a particular data space and other criteria. Once the initial data space is displayed in a visualization, the user may manipulate certain aspects of the graphic depiction of the data space to refine the parameters that create a data space in order to provide more relevant results in further searching and analysis.

In addition to the initial definition of the data space parameters, the population of the data space may be enhanced with symbols in order to jog user's memory and/or stimulate insight into the subject of the user's investigation. Further, users may interact with symbols in the data space in a more intuitive and graphic manner than through textual queries. Further interaction is possible with computational elements through symbols.

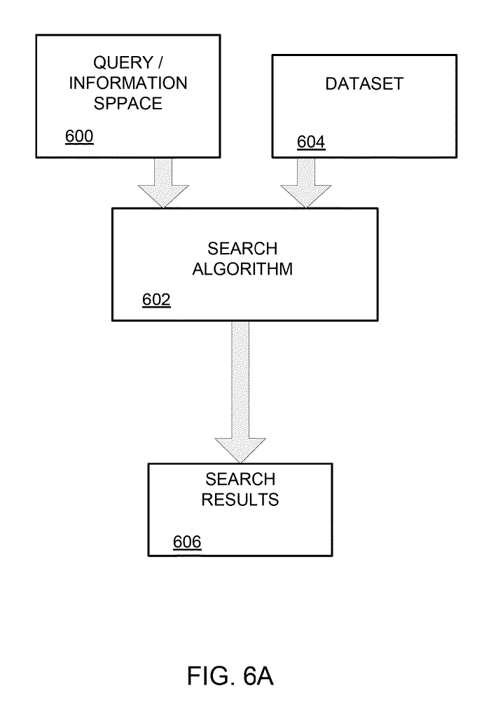

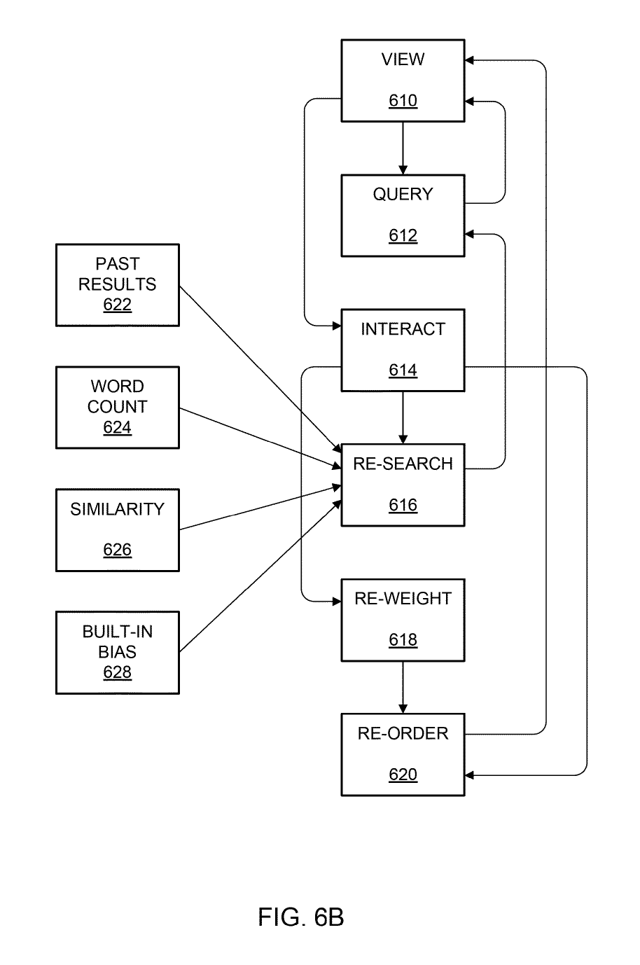

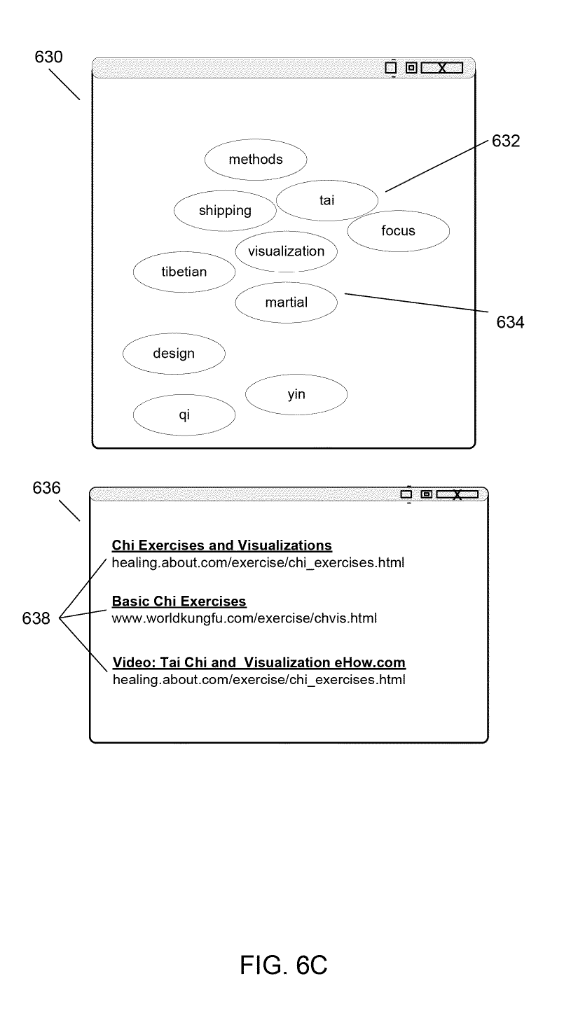

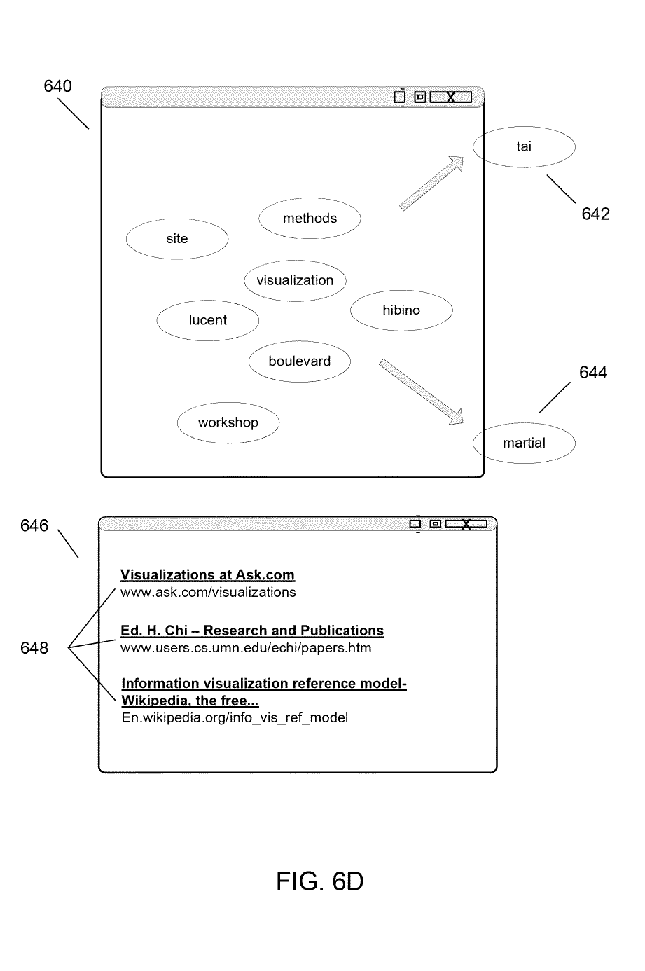

FIG. 6A illustrates a query operation according to one embodiment of the invention. In one embodiment, information space 600 represents a query intended for use in searching a dataset 604, for example dataset 604 may comprise a database, a document, a document collection, a web page, a web site, the World Wide Web, a collection of resumes or job applications or any collection of data rather structured or unstructured. In such an embodiment information space 600 comprises a query. Search algorithm 602 retrieves and ranks items from dataset 604, forming search result 606. In one embodiment, search result 606 is also an information space. When information space 600 is a query in a search, the tools provided by embodiments of the present invention for visualizing and manipulating an information space become powerful search tools. The user is able to control and guide the search and search algorithm.

In one embodiment where the information space 600 is a search query, search process 602 executes continuously and in real-time, such that changes to the query represented by information space 600 are reflected in search result 606 quickly enough that the operation appears to have no delay to a human user, providing an iterative and interactive search. When a user manipulates information space 600, the effect on the search result 606 is immediately visualized and a feedback loop is created; the user controls the search interactively. Thus a powerful interactive search tool is created.

In one embodiment of the invention, an investigation starts with a single query of a dataset based on one or more parameter items. The results of the query are displayed on a screen or tablet, with resultant specific instances being associated into multiple groups with each group having one or several items having similar information content. Each group is graphically placed in a predetermined location relative to the center of the space, the spacing of each group being indicative of its relevancy. In one embodiment, more relevant items or groups are displayed closer to the center of the visual environment so that the center becomes the point of highest relevance. In another embodiment, more relevant items or groups are displayed using larger fonts and/or accented colors. In still another embodiment, relevant items or groups are displayed on one of a plurality of levels, so that items or groups having similar relevancy are placed on the same level.

The user may then manipulate the groups, in one embodiment moving certain groups closer or farther away to indicate which groups of information appear more relevant to the user's query. In another embodiment, groups may have weighting buttons to allow the user to increase or decrease the importance, or weight, of that group to the query. In embodiments providing different levels, users may move such relevant items or groups amongst those levels (e.g., levels may be represented by a concentric circles or concentric rectangles and may users may move items or groups between zones or lines). As discussed in greater detail below, the user's modification of the original visualization of the query results may be used to refine how relevancy is determined by the query engine and/or displayed by the visualization tool. In addition, other system components may change the visualization of the query results based on changes in other information spaces.

The act of a user grouping certain query results or other items (generally “items” hereinafter) may be used to further enhance the tool. For example, after a user adds two or more items to a group, by examining the features of the grouped items the determination may be made that adding other items to the group will facilitate human recognition of patterns in the data, and may also compel or suggest repelling other items having opposite features. Additionally, groups may expand or contract depending on the similarity or dissimilarity of items forced into groups by the user.

FIG. 6B shows a flowchart of an exemplary embodiment of the present invention. Query 612 is created and displayed to the user in View 610. The user may Interact 614 with View 610, causing Re-Weight 618 of the search evaluation, Re-Order 620 of the results, and Re-Search 616 of the data space given the modified visualization, and Past Results 622, Word Count 624, Similarity 626, and Built-In Bias 628. These various processes may occur concurrently or in a predetermined sequence, with the focus on refining the query results towards the target of the inquiry.

After the meta-objects are defined, meta-object information is inherited by each of the features to redefine these data spaces in the same way as the meta-object spaces were defined. When an object is moved by the user that has already been selected as a human selected node, the full set of meta-objects are not recalculated. Instead, only the weights are updated, first up to the meta-objects and then back down to the features. This sequence facilitates faster processing as the selection of meta-objects is typically the most time intensive operation. However, if an item is dragged such that it crosses the significance barrier from negative to positive or the reverse, then this change is generally sufficiently significant that a complete recalculation is done.

FIGS. 6C and 6D illustrate how embodiments of the invention provide users immediate feedback for reflection, both by graphically presenting query results in groups with symbols, and also by spacing among and between various groups. For example, in several embodiments, two nodes that are closer together are more similar, whereas two nodes that are farther apart are less similar. Because the presentation is based on mapping an n-dimensional space into lower dimensional space, the definition of similarity may correspond to any of multiple dimensions in higher dimensional space.

Referring to FIG. 6C, A visualization environment display 630 is shown corresponding to a query based on “chi.” In this illustration the query is intended to search the World Wide Web, but these methods and techniques apply to an interactive search of any data set. Included in display 630 are two elements 632 and 634 that result from the initial search using the query. Also shown are search result display 636 and exemplary result list 638.

In this example, the user was not intending to find web pages related to “tai chi” or martial arts. The display shows that element 632 corresponding to “tai” and element 634 corresponding to “martial” are neatr the central place of greatest relevance. According to embodiments of the present invention, the user can interact with the visualization environment.

FIG. 6D illustrates an interactive search refinement according to an embodiment. Query display 640 has had element 642 corresponding to “tai” and element “644” corresponding to “martial” each moved away from the center and out of the visual environment. The result is apparent in result display 646 and the new result list 648, which contains web pages more relevant to the user's desired search.

Spacing may be used for indicating other relationships, as may illustrations like connecting lines (through the lines themselves, and/or color, thickness, hashing, etc.), shaded zones, or graphic symbols. Such illustration is generated automatically as a function of the computed relevance to the query.

Such illustrations and symbols provide a representational schema that visualizes the query results for human interpretation rather than computer analysis. Each particular query result may be thought of as a lens focused on a particular aspect of a data set. The visualization of the lens provides a representational schema that finds more highly similar data instances and visually groups those together or close for further investigation. In addition to providing a visualization, each query screen may be saved to that the user may return to that aspect of the data set when desired with minimal disruption.

The force layout is allowed to continuously update the visualization in attempting to validate the layout constraints imposed by similarity and centrality, by moving the computer generated nodes. This combination of Re-Search and Re-Weight is shown with greater particularity on FIG. 6B.

The dynamics of the interaction of data may be shown on displays by periodically or continuously repeating the query relative to the data set as time moves on. The sequential display of query visualization may reveal patterns in the data set that a single visualization cannot provide. This is in part a result of the tool not only comparing the feature-domains of the items displayed, but also comparing and basing visualizations on nested objection and nested relationships which may not be apparent when looking at the features themselves.

A second visualization may be used for meta-objects or any of the domains, to keep track of the ordered significance of those elements. This is primarily used for the meta-objects and allows easy back-integration into any search engine. This allows embodiments of the invention to keep a stable information space, even though related data may change in real time. A user may then move existing items, or use new query terms and items, moving and rearranging to see if any of the other items have a reaction with the moved or new query terms and items. In further embodiments, windows of two separate investigations may be combined to form new information spaces, and allow for the manipulation of items within the new space.

Information spaces of the type described in association with embodiments herein can be created in many ways and act in many roles in the process of information search, visualization, and exploration.

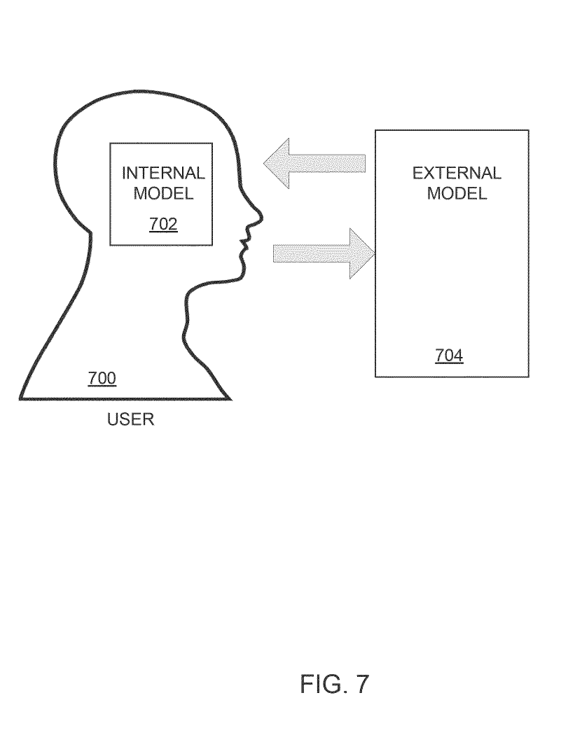

FIG. 7 illustrates creation of a query according to an embodiment of the invention. User 700 has mental model 702 and desires to create a similar external model 704. According to an embodiment of the present invention this is accomplished by iterating, manipulating, visualizing and reefing the query model.

Embodiments of the invention operate according to a general algorithm which is described in greater detail below, both in text and through a pseudo-code embodiment which may be implemented in various computing environments. In the following discussion, the following definitions are used to clarify the statements in the algorithm description and pseudo-code.

Element—This is a meta-object or a feature in a specific domain. An element contains a location in the space as well as an indication of whether it was generated by a human or the computer.

Meta-object search—Given a set of features for each domain and a set of meta-objects, returns a list of meta-objects that it predicts that the user might want in the space as well as a predicted location of those objects. This is the primary point of access for search algorithm integration.

Feature extraction—Given a set of features for each domain and a set of weighted meta-objects, returns a list of features predicted for each domain as well as predicted location of those features.

Relation module—Given a set of weighted elements, define, for each domain, similarity between every element within that domain.

Visualization module—Given a set of weighted elements, renders the objects in a meaningful way and allows user to move the objects to re-weight them or select/deselect as a user chosen object.

In several embodiments of the invention, objects are visualized separately for each domain. The importance of an object is signified by its centrality in each visual environment. Objects that are more similar are clustered closer together. This is achieved with a force-based layout with attractors of different strengths between nodes and the center. Alternative visualizations are also contemplated, but for simplicity the following description will concentrate exclusively on the force-based layout implementation.

The user may enter a new node into either the meta-object area or any of the feature areas by specifying it as a string or selecting an existing node that the computer has generated. When a new node is entered, the set of meta-objects is re-calculated. Objects that have had their location specified by the user are respected by the algorithm and not moved or removed. Instead, the algorithm attempts to predict new nodes that the user would be likely to want and to place them where it thinks the user would desire them to be positioned in the force-based layout. Meta-objects with the highest similarity to the defined search space are chosen as the new set of meta-objects. Returning meta-objects are placed in their previous location to maintain consistency in the visual environment.

In one embodiment, a window opens for each domain relative to a meta-object. Queries may be made in relatively simple space having one or two domains, but may also accommodate dozens of domains. Items may be displayed in one domain, and when the user manipulates the window of one domain, items will be influenced in other domains (whether or not currently displayed in a window). Thus, embodiments of the invention may be thought of as providing a high dimensional response to manipulations of a two or three dimensional display. The force-based manipulation may in some embodiments be implemented with a spring-replusion algorithm.

A feature of embodiments of the present invention is that it does not require standardized language be used to describe things. Instead, users of the tool described herein can provide classification and attach it to things previously written.

As an example, consider searching a collection of resumes to identify and filter those submitted by candidates whose resumes show qualifications for a particular job. For illustration, the job title is “protein chemist.” The user who is conducting the search is a subject matter expert who knows certain things about different words used in connection with this job in addition to the title “protein chemist.” For example, proteins are synthesized from peptides. Making many proteins fast is sometimes called proteomic. Chemists who make things are often called synthetic chemists. Chemists who work with biological chemicals are biochemists. It is possible that qualified candidates may use any of these terms on a resume.

If a search is conducted in a corpus of resumes for only “protein chemist,” qualified candidates who describe themselves as peptide chemist, synthetic chemist, biochemist, or proteomic chemist may not be identified as matching the search query. Embodiments of the invention leverage the fact that humans, who are often subject matter experts in the area in which they are searching, often understand which words or phrases have similar or identical meaning. Below is a description of applying an embodiment of the present invention in searching a corpus of resumes to identify candidates to fill a “protein chemist” position.

A user, who is a subject-matter expert, enters the original query phrase “protein chemist”. The interface of an embodiment of the invention subsequently shows all of the other words that the search algorithm has found to be highly correlated with the original query. If several of the resumes being searched contain something like “I am a biochemist who synthesizes peptides into proteins,” or, “I am synthetic chemist who uses proteomic technology to make proteins” the search algorithm has a good chance of returning the words “synthesize,” “peptide,” “proteins,” and “proteomic.”

Since protein, proteomic, peptide, biochemist, and synthetic are related to the desired search object, this embodiment of the present invention provides a tool to teach the computer that these words are related in meaning.

In using this tool, the user clicks one of the words (“peptide”), and, chooses “link” from the menu. A yellow line emerges from the word (“peptide”). One end of the yellow line stays attached to the original word (“peptide”). The user takes the cursor, and attaches the other end of the yellow line to any one of the other words displayed.

The user clicks the next word (e.g. “protein”). Consequently, the displayed words are pulled closer together, the yellow line thickens, the yellow line becomes orange, and the computer is now aware that “protein” and “peptide” should be treated as the same thing, in this context.

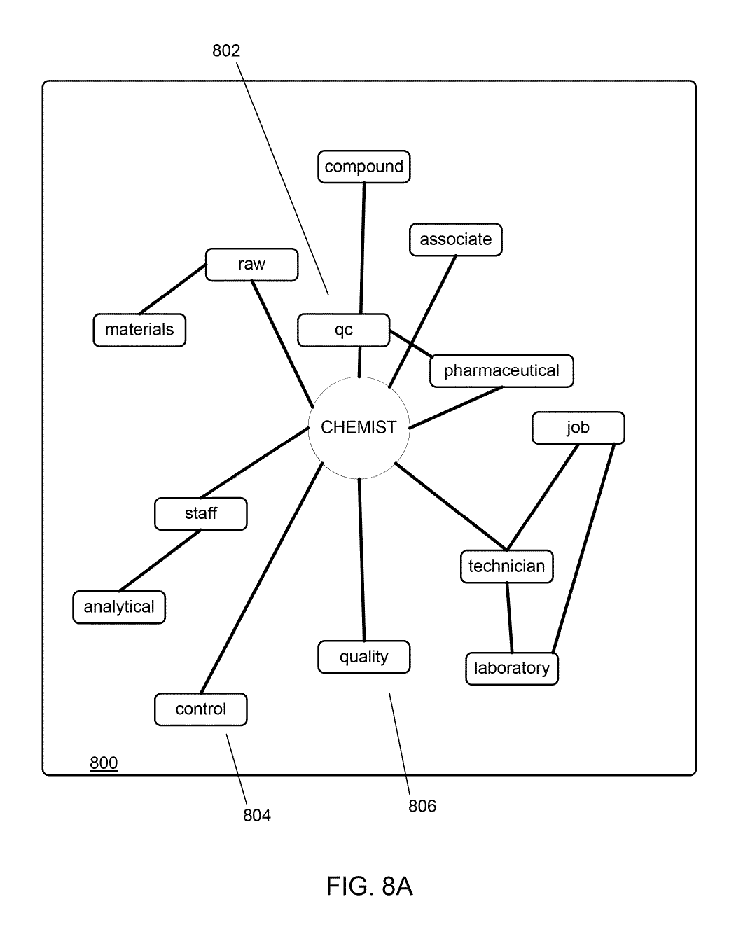

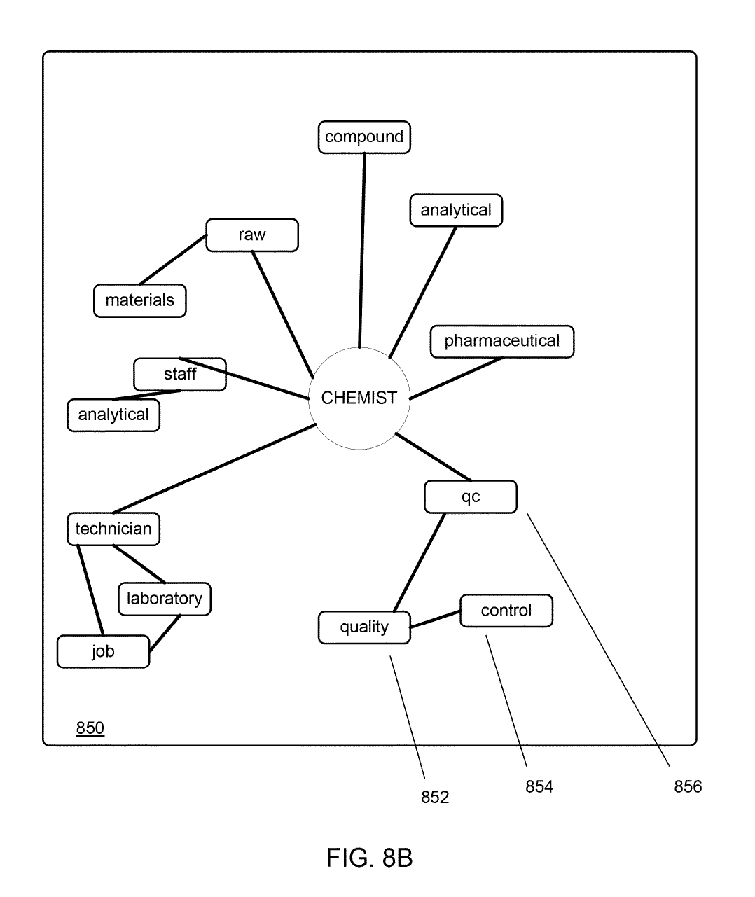

A similar process is shown in FIGS. 8A and 8B which illustrate interaction with an embodiment of a tool and guiding a search according to an embodiment of the present invention. This illustrates teaching the tool and associated model about similar meanings. A “Quality Control Chemist” is a chemist who tests a product to ensure it complies with standards for quality and purity.

It is trivial to implement a computer program to take two words and abbreviate them by their first two letters. For example, the words “Quality Control” are sometimes abbreviated as “QC.” However, in most cases performing this operation produces a meaningless abbreviation; not all two word sequences can be meaningfully abbreviated. In certain domains these abbreviations have meaning. “Private Investigator” is often abbreviated as “PI.”

It is difficult for a computer to identify two letter abbreviations that correspond to two word sequences that have an abbreviated alternate form. However, a subject matter expert in pharmaceuticals or plastics or chemistry will tell an algorithm quite confidently that “QC” is the same as “Quality Control” in the context of professional industry chemists.

Referring to FIG. 8A, the user has entered the query “Chemist” into a corpus of resumes. An embodiment of the invention returns the other words most highly-correlated (or, some of the other correlation choices we use to display impactful words) with the original query. This is shown in data visualization environment 800.

Continuing to refer to FIG. 8, data visualization environment 800 contains element 802 “qc,” element 806 “quality,” and element 804 “control,” as returned on the Daedalus tool. They are not near each other (signaling very-low value correlation). The user then links “control” to “quality” and “qc” to “control,” The system is now told that these three elements are to be considered highly correlated. This is accomplished, for example, by using menus, mouse-sensitive area and objects, and color-coded connecting lines.

The new information from these user-generated linkages cause the search results to update to create a feedback loop that reveals to the user what impact their linking has had on the search results. The update is reflected in FIG. 8B, wherein data visualizarion display 850 now shows linkages between element 852 “quality,” element 854 “control,: and element 856 “qc.” The system has captured the knowledge that these elements are related by similar meaning in the present context.

In one embodiment, an individual user has an account that allows persistent data. When the data is later searched again from the same account, the correlation remains.

In one embodiment, the account is mapped to an organization, department or group. If this were part of a larger organization, the correlation may optionally be presented to other users or overrun by other users. Multiple accounts (and, say, generic accounts for different departments) may also be used so that the specialized language of one division does not impact the language of another.

An important result is that what was previously important knowledge trapped only in the head of the one user, is now institutionalized in an online data storage system of the organization. Thus, embodiments of the present invention let users tell these systems which words or tags should be linked.

Also, such links between words or phrases include more discrete and specific links with specific types of connections between words. Both established approaches in semantic modeling and/or data modeling may be used, or alternatively a new classification scheme of linkages may be implemented including allowing users to create their own semantic linkages. This allows embodiments of the invention to define over trivial derivations of the type of connections between words.

Embodiments of the invention also allow users to increase or decrease the strength of the connection. Thus, a user may make the connection between “qc” “quality” and “control” even tighter, for example by increasing the value of the connection by a quantitative or qualitative measure. Alternatively, the user may make the connection less tight, for example by decreasing the value of the connection by a quantitative or qualitative measure.

Embodiments of the invention allow users to bond words in subsets and macro-sets to more specifically map to the user's intentions in user defined linkages. In the example above, this may mean that it is only slightly true that “qc”=“quality”=“control.” It's more true to say “qc”=“quality”+“control”. Embodiments of the invention enable users to engage this functionality so that “qc” may equal the appearance of “quality control” and not just “quality” AND “control”.

Various embodiments of the invention allow use of search terms including Boolean logic functions common to current search engines. These include AND, OR, and wildcard or * (which allows the engine to search for anything that contains part of a word—i.e. searching for “engine*” will deliver both “engineer” and “engine”). Embodiments of the invention also provide a ‘forward-wildcard’ or ‘forward-*’ which would allow one to search for endings (i.e. searching for “*ing” would include all words like “searching” “walking” and “standing” in the query, in case, say, the user was looking for gerunds in a digital corpus or text.)

In addition, embodiments of the invention may use several different identifiers or signifiers in visual representations. For example, a chain-link icon or a gear icon may be used interchangeably in some embodiments, while in other embodiments the distinction may be more than trivial if one signifier implies a different quantitative or qualitative value. Other exemplary alternate visual identifiers include variations in line style or color. In further embodiments, circles may be used instead of rectangles to surround a word in the visualization of a search.

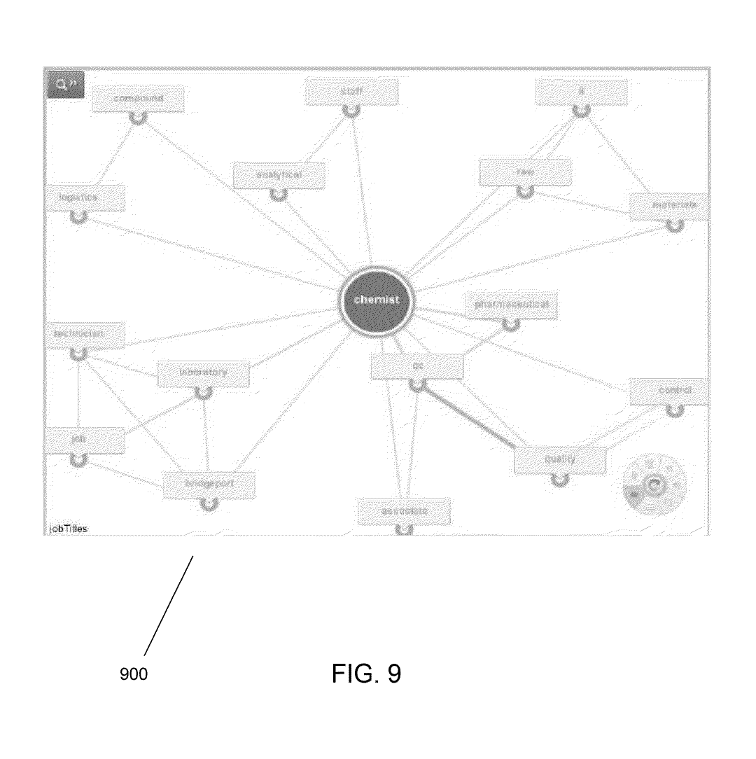

FIG. 9 shows a screen shot of the Daedelus data visualization tool in use. Display 900 is a visualization environment corresponding to a data set.

While the foregoing exemplary embodiments show a two-dimensional representation of the data space, other embodiments of the invention operate on higher dimensions. Although multi-dimensional spaces are often difficult to visualize, by projecting a multi-dimensional space onto a two or three dimensional visualization, embodiments of the present invention allow for extension of the tool into such complex data spaces.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

Pseudo-Code Appendix

```
/*
A feature can be either a metaobject such as a web page, or a feature in
that meta object such as a word (in the description domain).
*/
Feature
  var point location
  var point velocity
  var hash similarity
  var boolean human_added
  var Object representation
  var real weight
/*
Visualization takes care of rendering, movement and human interaction.
This passage articulates how the data how the visualized, how its
dynamics evolve, and how the human can manipulate both.
*/
visualization
  function tick {
    foreach feature {
      // Calculate force vector.
      force = (0,0)
      // Force toward center.
      force += center_force((center − feature->location),
      feature->weight)
      // Force for each other vector attractive and repulsive.
      foreach feature2 {
        force += attractive_force((feature->location − feature2-
        >location),
feature->similarity(featur2)
        force −= repulsive_force(feature->location − feature2->location)
      }
      // update physics.
      feature->velocity += c * force
      feature->location += feature->velocity
      if(feature->human_added) {
              setColor(color1)
      } else {
              Set_color(color2)
      }
      draw_circle(feature->location (location), feature->significance
      (radius))
    }
  }
  function onMouse {
    selected = get_selected_feature( )
    if selected->human_added {
      selected->location = mouse->location
      if crosses_significance_boundary {
        recalculate_big( )
      } else {
        recalculate_small( )
      }
    } else {
      selected->human_added = true
      recalculate_big( )
    }
  }
/*
Similarity calculates similarities between features based on environment.
Similarities are composed of meta-objects weighting features and features
weighting meta-objects in some way.
*/
Similarity
  function recalculate_big {
    metaObjectList = request_meta_objects( )
    recalculate_small( )
  }
  function recalculate_small {
    // Find all relevant features.
    featureList = { };
    foreach metaobject {
      featureList union equals metaobject->getFeatures( )
    }
    // Convert to feature objects.
    foreach feature {
      if(old_feature_list.contains(feature)) {
        feature_list.add(old_feature_list.get(feature))
      } else {
        feature_list.add(Feature(feature))
      }
    }
    // Calculate feature weight from meta-objects.
    foreach feature {
      feature->weight = 0
      foreach metaobject {
        feature_weight += meatobject->weight *
similarity_feature(metaobject,feature)
      }
    }
    // Calculate meta-object weight from features.
    foreach metaobject {
      metaobject->weight = 0
      foreach feature {
        metaobject_weight += feature->weight *
similarity_metaobject(metaobject,feature)
      }
    }
    // Calculate feature similarity from meta-objects
    foreach feature {
      foreach feature {
        foreach metaobject {
          feature1->similarity(feature2) += similarity(metaobject,
feature1,feature2) * metabobject->weight
        }
      }
    }
  }
  function reguest_meta_objects {
    http_request_search_engine(featureList->human_words,
metaobjectlist->human_metaobjects);
    // Search usually base only on featureList keywords.
    return build_metaobjects_from_search_results( );
  }
  function similarity_feature(metaobject,feature) {
    // Similarity is the fraction of the features that are this
particular feature.
    // Can take distance information into account if available.
    return metaobject.count_feature(feature) /
metaobject.count_features( )
  }
  function similarity_metaobject(metaobject,feature) {
    // Similarity is the fraction of occurrences of this feature that
happen to be in this metaobject.
    return feature.count_meta_object_occurences(feature) /
metaobject.count_feature(feature);
  }
  function similarity(feature1, feature2, metaobject) {
    // Similarity is the number of times that both features occur in
this meta object.
    // Can take global similarity information into account here if
available.
    return min(metaobject.count_feature(feature1),
metaobject.count_feature(feature2))
  }
```

### Alternative Pseudo-Code for the 11^{th} Iteration of the Standard Interaction

### For the Function Tick

“Tick” is a layout tool that organizes the nodes in the information space. It may be a single step or an approach. We have chosen to code it in the above manne, however, this can be accomplished in several ways. A non-complete subset of the many other ways this function (“tick”) could be accomplished.
Multi-dimensional scaling
Principal component analysis
t-SNE
Gravitational models
Non-negative matrix decomposition

### For Rendering (in the Tick Function)

For rendering choices, there is a move in the initial iteration for minimalism—this allows us to retain a number of elements for use later when the tool needs to express more information. Additional rendering choices that can be used to express information are listed below (but are not limited to):
Shape of node
Texture of node
Rotation of node (different shapes)
Color of node
Opacity of node
Size of node
Depth (in information space) of node placement
Momentum of node
System Dynamics of interacting nodes
Standard/already known relationships
Connecting Graph connections between the nodes
Type of text (font, style, size)
Radius of words proportional to word commonality (and proportion)
Color of background map (for example, heat mapping)
Other senses can of course evoked for information as well (for example, a range of sounds that correlates with low-high weights, or, the ‘chords’ that could occur to signify the relations between nodes)
Tracing/Trailing as node moves (for example, a node that is “heavily rooted” in the information space may leave a trail as it is moved, whereas a node that is only lightly “rooted” in the space would leave no trace/trail)
   N-dimensional rendering: while the pseudo code above is a two-dimensional rendering, 1-2-3- or 4-dimensional renderings are entirely possible (indeed n-dimensional).

### For the On-Mouse Function

Can also be accomplished with joystick, or gamepad, or any other n-dimensional device.
Can also be accomplished with a 3D mouse.
Can also be used to achieve affine transformation the information space (or, an information space within an information space).
Can also act as an attractor unto itself—when the meta-object is held by click, it can become an attractive and repulsive force itself as it is moved about the space (interacting with other nodes)

### For Function Update_Meta-Objects

In the pseudo-code above, the system only updates when the user interacts with the data through the interface. The update can accomplished in a number of ways, though, and, be used in different ways as well.
It can be updated automatically at a consistent basis.
It can be updated by user request
It can be updated by asynchronous by systems request
The features that update the meta-object can have binary or continuous re-weighting impact on the query
A meta-object can be more or less likely to be re-selected if it has been selected in the past.
   This is primarily where our system interacts with search algorithms, and the individual tactics used in that search will vary.

### For Function Similarity

In function similarity, we're using the strength of the human objects and meta-objects to predict the strength of the human objects and meta-objects. There are two parts to this. One is the overall calculation algorithm and one is the single similarity for feature a meta-object or a meta-object given a feature. Those are the two bulleted lists below.

The similarity of a feature given a meta-object and meta-object given a feature can be accomplished using:
Topics model
Complex Bayesian
Multiple semantic space models (BEAGLE, LSA, HAL, etc).
   The way that the above metrics are used to calculate overall similarities and strengths can be performed either as described, or using:
PageRank
N-times recursive (where features feed into meta-objects which feed into features, etc)
Mixture model end-behavior (using linear algebra to determine the approached-values of running n-recursion an infinite number of times)
Values can be augmented with a general word-importance and similarity measures

### Control Console

A control console is included in the tool to enable users to control how much the different variables can impact their experience and functionality. Some examples of choices that users can make are (but are not limited to):
Select or deselect domains of information for visualization, interaction, or impact.
Select colors
Select attraction/repulsion strengths
Select deading constant
Select number of nodes
Select semantic space model impact
Select organizing layouts

What is claimed is:

1. A method of using a computer to visualize a query of a data space, said method comprising the steps of:
displaying a first set of objects resulting from an initial search parameter;
allowing manipulation of the first set of objects on the display; and
displaying a second set of objects created from a new query based on the manipulation of the first set of objects.

2. The method of claim 1 further comprising the step of allowing the user to link two or more objects.

3. The method of claim 2 wherein the step of allowing the user to link involves allowing the user to specify a quantitative or qualitative value with the link.

4. The method of claim 1 wherein the step of manipulation includes allowing graphic manipulation of the visual display of the first set of objects.

5. A search visualization system comprising:
a processor in communication with a search engine;
a display coupled to said processor;
a memory coupled to said processor, said memory adapted to store communications with the search engine, said memory including a plurality of instructions enabling said processor to: send the search engine an initial search parameter, display a first set of objects received from the search engine relating to the initial search parameter, allow manipulation of the first set of objects on the display, create a second search parameter based on the manipulation, send the second search parameter to the search engine, and display a second set of objects received from the search engine relating to the second search parameter.

6. The system of claim 5 further including an information space database stored in said memory, said information space database including stored data relating history of the manipulations.

7. The system of claim 6 wherein said memory has a plurality of instructions enabling said processor to modify search parameters to the search engine according to data stored in said information space database.

8. The system of claim 7 wherein said memory has a further plurality of instructions enabling said processor to selectively extract data relating to history of the manipulations.

9. The system of claim 7 wherein said memory has a further plurality of instructions enabling said processor to receive external data relating to history of manipulations from a second information space database and to insert the external data into said information space database.

10. The system of claim 5 wherein said memory has a plurality of instructions enabling said processor to allow manipulation in the form of linking two or more objects.

11. The system of claim 10 wherein said memory has a plurality of instructions enabling said processor to allow the user to specify a quantitative or qualitative value with the link.

12. The system of claim 5 wherein said memory has a plurality of instructions enabling said processor to allow graphic manipulation of the visual display of the first set of objects.
